(19) United States
(12) Patent Application Publication
(10) Pub. No.: US 2020/0079454 A1
(43) Pub. Date: Mar. 12, 2020

(54) BICYCLE SADDLE

(71) Applicant: Yong Joo KIM, Chuncheon-si, Gangwon-do (KR)

(72) Inventor: Yong Joo KIM, Chuncheon-si, Gangwon-do (KR)

(21) Appl. No.: 16/301,976

(22) PCT Filed: Jul. 4, 2017
(86) PCT No.: PCT/KR2017/007092

§ 371 Date: Nov. 15, 2018

(30) Foreign Application Priority Data
Jul. 12, 2016 (KR) 10-2016-0088171
Dec. 21, 2016 (KR) 10-2016-0175317

(51) Int. Cl. B62J 1/08; B62J 1/02; B62J 1/00

(52) U.S. Cl. CPC B62J 1/08; B62J 1/007; B62J 1/02

(57) ABSTRACT

The present invention relates to a bicycle saddle, which comprises: at least one cushion part on which a bicycle rider's buttocks are stably placed; a support frame including at least one support panel and an air inducing part, the support panel being coupled to a lower part of the cushion part to support the cushion part, the air inflow part having a central part formed in a concave shape; and an elastic frame, which is coupled to a lower part of the support frame and has a lower surface convexly curved downward.

### TECHNICAL FIELD

The present invention relates to a bicycle saddle, and more particularly, to a bicycle saddle, which can minimize shock applied to a rider's buttocks by dispersing the rider's weight and absorbing shock and provide pleasant and comfortable quality of riding even though the rider rides for a long time.

### BACKGROUND ART

In general, Korean Utility Model Registration No. 20-0400602 discloses a bicycle saddle. As disclosed, the entire bicycle saddle comes in contact with a rider's buttocks to apply a strong pressure to the rider's buttocks.

Such a conventional bicycle saddle has a shock mitigation structure to a bicycle body with which the bicycle saddle is combined in order to solve shock applied to the rider's buttocks due to the rider's weight and uneven road conditions.

However, when the rider rides a bicycle for a long time, the conventional bicycle saddle is difficult to solve shock, and it may cause a significant problem to the rider's body.

Moreover, the conventional bicycle saddle, which entirely comes in contact with the rider's buttocks, gives a shock to the rider's perineal area unavoidably during riding due to the rider's weight and uneven road conditions. Especially, if the rider rides for a long time while being shocked, it causes a considerable thlipsis of the perineal structure, so it may considerably reduce sensitivity of the penis.

Furthermore, the rider continuously squeezes the muscles during sitting on the saddle due to irregular shocks generated and pressure applied to the perineal area during riding, and it increases the rider's fatigue due to muscular rigidity.

In the meantime, prostatitis is common in men older than 50. If inflammation is developed in the prostate, the prostate gets gradually swollen, and finally, causes urethremphraxis. Consequently, it causes a great problem to urination. Patients feel displeasure and discomfort in an early stage of prostatitis, but prostatitis causes painful and serious results while being progressing gradually.

Such diseases may be cured through transurethral prostatic resection (TURP) or surgical procedures, but such methods may cause intense pains, oligemia, morbidity, complications, high expenses, waste of time, and so on, and in severe cases, may cause death.

Therefore, people need a bicycle saddle, which is free from various diseases related with the anus and the sexual organs, such as prostatitis, constipation, hemorrhoids, and urinary incontinence and can maintain pleasant conditions.

### DISCLOSURE

### Technical Problem

Accordingly, the present invention has been made in view of the above-mentioned problems occurring in the prior art, and it is an object of the present invention to provide a bicycle saddle, which can minimize shock applied to a rider's buttocks by a support frame and an elastic frame providing cushioning and elasticity, thereby enhancing the quality of riding.

It is another object of the present invention to provide a bicycle saddle, which can provide a pleasant and comfortable feeling of riding since air is continuously induced to the rider's perineal area by an air inducing part and an air inflow part of the support frame when the rider rides on a bicycle and can prevent various diseases, such as prostatitis, constipation, hemorrhoids, and urinary incontinence caused by a long-term riding.

It is a further object of the present invention to provide a bicycle saddle, which includes a plurality of cushion panels formed on the cushion part individually so as to individually do an elastic movement, thereby effectively dispersing load and shock applied to the saddle under various riding conditions, such as normal riding, right and left rotations, and sudden stop of the bicycle.

### Technical Solution

To accomplish the above object, according to the present invention, there is provided a bicycle saddle including: at least one cushion part on which a rider's buttocks are placed; a support frame including at least one support panel and an air inducing part, the support panel being combined with a lower part of the cushion part to support the cushion part, the air inflow part having a central part formed in a concave shape; and an elastic frame, which is combined with a lower part of the support frame and has a lower surface convexly curved downward.

The cushion part is divided into a first cushion panel and a second cushion panel, which are bilaterally symmetric, by the air inflow part of the support frame, and the first cushion panel and the second cushion panel protrude outwardly to be curved with respect to the air inflow part so that through holes are formed therein.

The cushion part is divided by the air inflow part of the support frame to be bilaterally symmetric, so that a first cushion panel, a second cushion panel, a third cushion panel, and a fourth cushion panel, which are combined with both end portions in a longitudinal direction of the air inducing part, are formed to individually do an elastic movement.

The elastic frame includes an empty elastic space to improve an elastic strain by shock vibration.

A permanent magnet is attached to the inner circumferential surface in which the air inflow part is formed.

The support frame further includes another air inflow part formed at one side of the inner circumferential surface of the air inflow part in order to induce air in the direction of the rider's buttocks.

The elastic frame further includes a fastening member to be rotatably combined with a bicycle body.

### Advantageous Effects

As described above, the bicycle saddle according to the present invention can minimize shock applied to a rider's buttocks by a support frame and an elastic frame providing cushioning and elasticity, thereby enhancing the quality of riding.

Moreover, the bicycle saddle according to the present invention can provide a pleasant and comfortable feeling of riding since air is continuously induced to the rider's perineal area by an air inflow part and another air inflow part of the support frame when the rider rides on a bicycle and can prevent various diseases, such as prostatitis, constipation, hemorrhoids, and urinary incontinence caused by a long-term riding.

Furthermore, the bicycle saddle according to the present invention, which includes a plurality of cushion panels formed on the cushion part individually so as to individually do an elastic movement, can effectively disperse load and shock applied to the saddle under various riding conditions, such as normal riding, right and left rotations, and sudden stop of the bicycle.

### DESCRIPTION OF DRAWINGS

FIG. 1 is a plan view of a bicycle saddle according to an embodiment of the present invention.

FIG. 2 is a sectional view showing a brief cross section of the bicycle saddle.

FIG. 3 is a sectional view showing another structure of an elastic frame applied to the bicycle saddle.

FIGS. 4A to 4G are plan views showing various forms of the bicycle saddle according to the embodiment of the present invention.

FIGS. 5A to 5F are plan views showing various forms of the bicycle saddle according to another embodiment of the present invention.

FIG. 6 is a perspective view showing a preferred example of a support frame of the bicycle saddle.

### MODE FOR INVENTION

Hereinafter, exemplary embodiments of the present invention will be described with reference to the accompanying drawings. In the drawings, the same elements will be designated by the same reference numerals. Further, in the following description of the present invention, a detailed description of known functions and configurations incorporated herein will be omitted when it may make the subject matter of the present invention rather unclear.

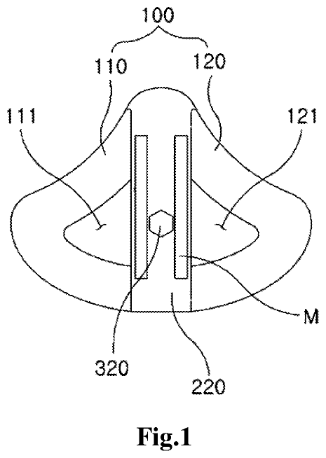

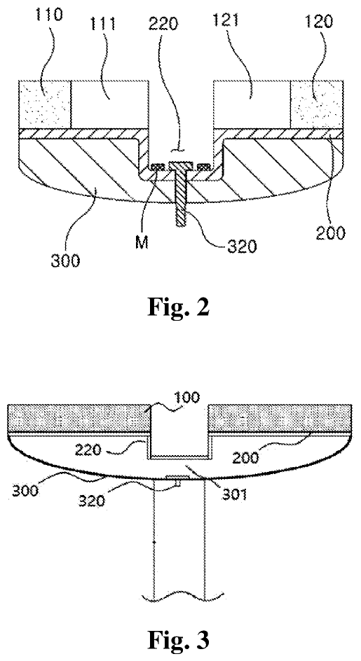

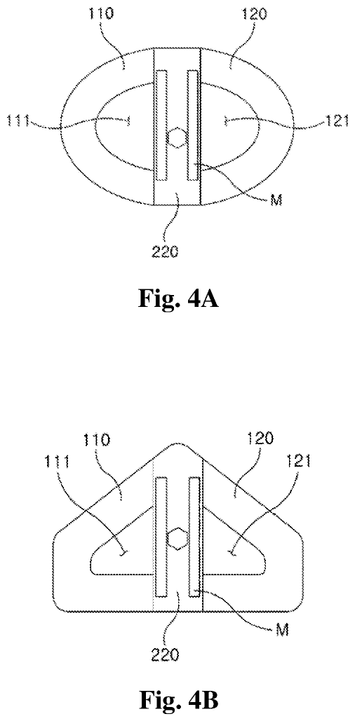

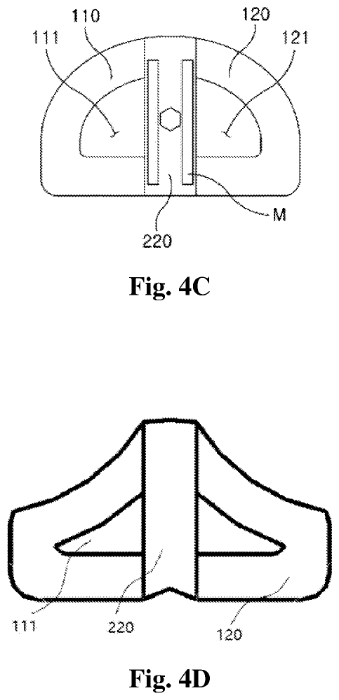

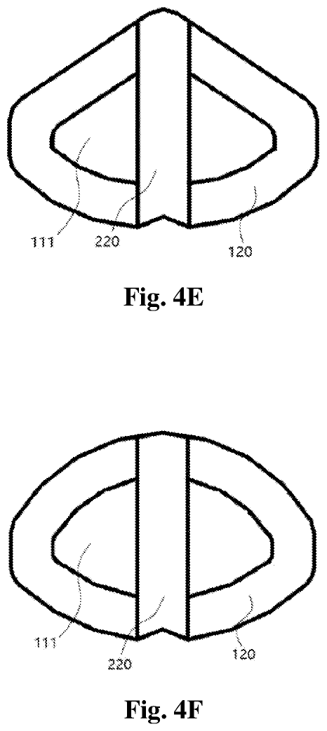

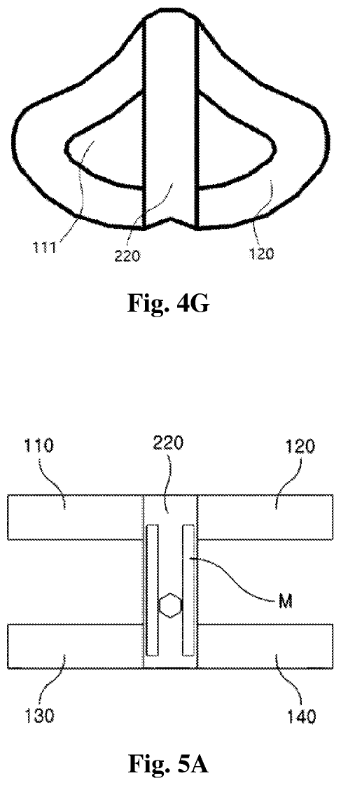

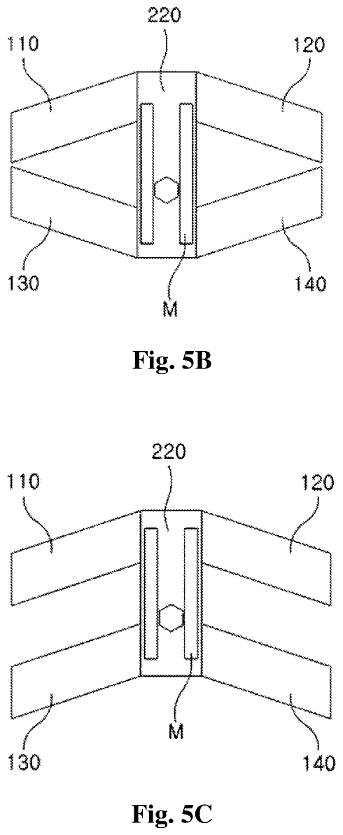

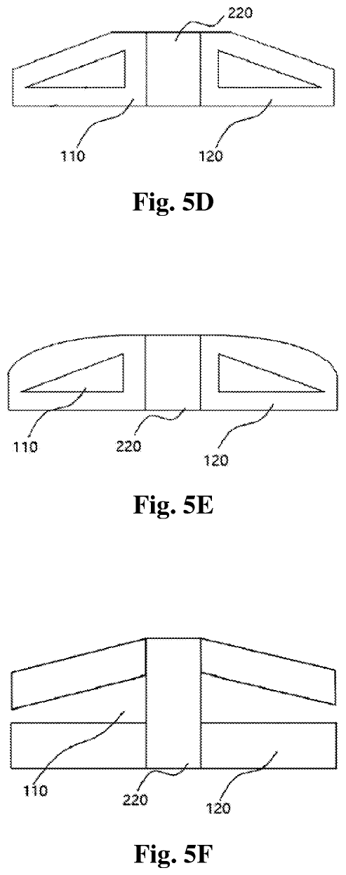

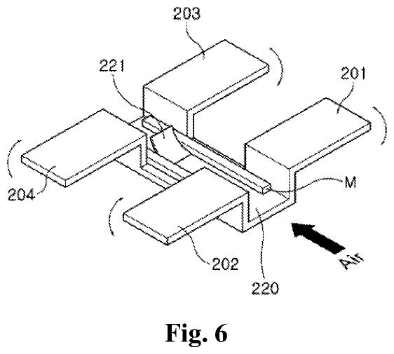

FIG. 1 is a plan view of a bicycle saddle according to an embodiment of the present invention, FIG. 2 is a sectional view showing a brief cross section of the bicycle saddle, FIG. 3 is a sectional view showing another structure of an elastic frame applied to the bicycle saddle, FIGS. 4A to 4G are plan views showing various forms of the bicycle saddle according to the embodiment of the present invention, FIGS. 5A to 5F are plan views showing various forms of the bicycle saddle according to another embodiment of the present invention, and FIG. 6 is a perspective view showing a preferred example of a support frame of the bicycle saddle.

Hereinafter, reference will be now made in detail to the preferred embodiments of the present invention with reference to the attached drawings.

As shown in the drawings, the bicycle saddle according to the embodiment of the present invention includes a cushion part 100, a support frame 200, and an elastic frame 30.

The cushion part 100 is located at the uppermost end of the bicycle saddle, and as shown in FIGS. 1 and 2, at least one cushion part, on which a rider's buttocks are placed, may be formed.

In this instance, the cushion part 100 is made of a cushiony material, such as Styrofoam, memory foam, or urethane foam, in order to absorb shock.

In the meantime, as shown in FIG. 3A, the cushion part 100 is divided into a first cushion panel 110 and a second cushion panel 120, which are bilaterally symmetric, by an air inflow part 220 of the support frame 200. The first cushion panel 110 and the second cushion panel 120 protrude outwardly to be curved with respect to the air inflow part 220 so that through holes 111 and 121 are formed therein.

In this instance, the through holes 111 and 121 are to aerate a rider's buttocks, so provide pleasant riding conditions by rapidly drying sweat or moisture.

Moreover, as shown in FIGS. 4A to 4G, preferably, the cushion part 100 may be manufactured in various forms according to riders' body types or sizes of buttocks.

In the meantime, as shown in FIGS. 5A to 5F, the cushion part 100 has a straight flat plate structure that is divided by the air inflow part 220 of the support frame 200 to be bilaterally symmetric, so that a first cushion panel 110, a second cushion panel 120, a third cushion panel 130, and a fourth cushion panel 140, which are combined with both end portions in a longitudinal direction of the air inflow part 220 respectively, are formed to individually do an elastic movement.

Such a cushion part 100 can vary positions that load or shock is applied to the saddle according to various riding conditions, such as normal riding, right and left rotations, and sudden stop of the bicycle, and effectively disperse load and shock since the cushion panels can individually do elastic movement in order to cope with the various riding conditions.

Meanwhile, the support frame 200 includes one or more support panels 201, 202, 203 and 204, which are combined with a lower portion of the cushion part 100 to support the cushion part 100, and an air inflow part 200 formed in a U-shape at the central portion.

It is preferable that the support frame 200 be made of a metallic material with elasticity, and the support panels 201, 202, 203 and 204 extend integrally with the support frame in order to disperse shock, which has not been absorbed by the cushion part 100.

That is, according to the rider's weight or road conditions, the cushion part 100 first absorbs shock applied to the bicycle saddle, and then, the support panels 201, 202, 203 and 204 disperse the rest shock using their elasticity, so as to provide pleasant feeling of riding.

Here, it is natural that the support panels 201, 202, 203 and 204 have the shape and structure corresponding to the first, second, third and fourth cushion panels 110, 120, 130 and 140.

The support panels 201, 202, 203 and 204 are spaced apart from each other with respect to the air inflow part 220 and maintain horizontality.

The air inflow part 220 has an alphabet “U” shape that a central portion of the support frame 200 is hollowed downward. So, because an upper portion of the air inflow part 220 is open, the rider's perineal area can come in contact with air since air passes through the air inflow part 220 during riding.

Furthermore, because the air inflow part 220 makes the saddle spaced apart from the rider's perineal area at a predetermined interval, the bicycle saddle can prevent direct friction pressure and vibration from being transferred to the perineal area, and make the rider's perineal area maintain a pleasant condition by the air induced through the air inflow part 220.

Additionally, a permanent magnet (M) is attached to an inner circumferential surface forming the air inflow part 220.

Here, preferably, the permanent magnet (M) is a rare-earth element based neodymium magnet (Nd-Fe-B magnet), and such a permanent magnet continuously emits magnetic fields and anions around the rider's perineal area so as to induce magnetism to iron contained in blood of a human body as a main ingredient of hemoglobin to promote blood circulation.

Moreover, the support frame 200 forming the air inflow part 220 is manufactured by mixing magnet powder (not shown) and may show the same action as the permanent magnet (M) through a magnetization process.

Furthermore, a receiving case (not shown), which is detachably attached to the saddle according to the size of the air inflow part 220 through the permanent magnet (M), may be additionally mounted.

Additionally, the receiving case may be manufactured with the permanent magnet, and has a medicinal stuff part for curing prostatitis, prostatic hypertrophy, prostate cancer, and so on therein.

In this instance, the medicinal stuff part includes at least one among mugwort, dried green tea leaves, artemisia capillaris, hardwood charcoal, taraxacum herb, duckweed, cnidium, peppermint, Clematis florida, and so on.

The medicinal stuff part contains powder type or finely cut medicinal stuffs therein. When air is induced into the air inducing part, the medicinal stuffs move toward the rider's perineal area to infiltrate effective ingredients.

Of course, the receiving case has a plurality of vent holes, and the medicinal stuffs are discharged through the vent holes. It is preferable that the medicinal stuffs be arranged in a driving direction. That is, the medicinal stuffs discharged through the vent holes move backward together with wind blowing from the front. Active ingredients of the medicinal stuffs moving backward are infiltrated into the rider's prostate, scrotum, anus, and perineal area.

In the meantime, the elastic frame 300 is combined with the lower portion of the support frame 200 and has an arch structure that a lower surface is convexly curved downward to disperse load applied to the cushion part 100 and the support frame 200.

The elastic frame 300 having the lower portion formed in the arch shape has an advantage in that a shock absorption amount is increased since a strain due to a vertical vibration is large.

Furthermore, the elastic frame 300 may serve as a stiffener to minimize deformation of the cushion part 100 and the support frame 200 due to a long-term riding.

Additionally, the elastic frame 300 may be a plate spring having an empty elastic space 301 in order to increase an elastic strain by shock and vibration (See FIG. 3).

In the meantime, as shown in FIG. 6, the support frame 200 may further include another air inflow part 221 formed at one side of the inner circumferential surface of the air inflow part 220 in order to induce air in the direction of the rider's buttocks.

In this instance, the air inflow part 221 is formed to be able to rotate so that the rider can selectively open and close the air inflow part 221 according to his or her taste.

The air inflow part 221 induces the air induced into the air inflow part 220 toward the rider's perineal area. For instance, if the rider drives the bicycle fast, since air simply passes the air inflow part 220, the bicycle saddle according to the present invention can effectively form an air passage using the air inflow part 221.

In the meantime, the elastic frame 300 may further include a fastening member 320 to be rotatably combined with a bicycle body.

That is, through the fastening member 320, the cushion part 100 and the support frame 200 combined with the elastic frame 300 may turn 180 degrees or may be separated from each other. In addition, the fastening member 320 can minimize imbalanced deformation of the first and second cushion panels and the first and second support panels disposed at the front and the third and fourth cushion panels and the third and fourth support panels disposed at the rear according to the rider's usage habits, and reduce expenses for replacement and repair since the position can be changed even though there is an imbalance.

As described above, while the present invention has been particularly shown and described with reference to the example embodiments thereof, it will be understood by those of ordinary skill in the art that the present invention is not limited by the embodiment and the attached drawings and various changes, modifications and equivalents may be made therein without departing from the technical idea and scope of the present invention.

1. A bicycle saddle comprising:
at least one cushion part (100) on which a rider's buttocks are placed;
a support frame (200) including at least one support panel (201) and an air inflow part (220), the support panel being combined with a lower part of the cushion part (100) to support the cushion part (100), the air inflow part (220) having a central part formed in a concave shape; and
an elastic frame (300), which is combined with a lower part of the support frame (200) and has a lower surface convexly curved downward.

2. The bicycle saddle according to claim 1, wherein the cushion part (100) is divided into a first cushion panel (110) and a second cushion panel (120), which are bilaterally symmetric, by the air inflow part (220) of the support frame (200), and the first cushion panel (110) and the second cushion panel (120) protrude outwardly to be curved with respect to the air inflow part (220) so that through holes (111, 121) are formed therein.

3. The bicycle saddle according to claim 1, wherein the cushion part (100) is divided by the air inflow part (220) of the support frame (200) to be bilaterally symmetric, so that a first cushion panel (110), a second cushion panel (120), a third cushion panel (130), and a fourth cushion panel (140), which are combined with both end portions in a longitudinal direction of the air inflow part (220) respectively, are formed to individually do an elastic movement.

4. The bicycle saddle according to claim 1, wherein the elastic frame (300) includes an empty elastic space (301) to improve an elastic strain by shock vibration.

5. The bicycle saddle according to claim 1, wherein a permanent magnet (M) is attached to the inner circumferential surface in which the air inflow part (220) is formed.

6. The bicycle saddle according to claim 1, wherein the support frame (200) further includes another air inflow part (221) formed at one side of the inner circumferential surface of the air inflow part (220) in order to induce air in the direction of the rider's buttocks.

7. The bicycle saddle according to claim 1, wherein the elastic frame (300) further includes a fastening member (320) to be rotatably combined with a bicycle body.
